(19) United States
(12) Patent Application Publication
(10) Pub. No.: US 2016/0095680 A1
(43) Pub. Date: Apr. 7, 2016

(54) METHOD AND APPARATUS FOR SCALING TEETH

(71) Applicant: Sung Suk CHOI, Gwangju (KR)

(72) Inventor: In Jae KIM, Gunpo-si, Gyeonggi-do (KR)

(21) Appl. No.: 14/893,447

(22) PCT Filed: Apr. 24, 2014
(86) PCT No.: PCT/KR2014/003598

§ 371 Date: Nov. 23, 2015

(30) Foreign Application Priority Data
May 24, 2013 (KR) 10-2013-0058949

(51) Int. Cl. A61C 17/20; A61C 17/06; A61C 1/00

(52) U.S. Cl. CPC A61C 17/20; A61C 1/0007; A61C 17/043

(57) ABSTRACT

Disclosed is a tooth scaling method for removing calculus, and the tooth scaling method may comprise the steps of: sensing a parameter difference between a scaler tip and a suction tip or a parameter change of each of the scaler tip and the suction tip using a sensor unit; determining whether the parameter difference or each of the parameters changes within a reference range, which appears when the scaler tip contacts a tooth and the suction tip is positioned inside the oral cavity, or not; and activating the scaler tip and the suction tip when the parameter difference or each of the parameters is included in the reference range.

### TECHNICAL FIELD

The present application relates to a method and apparatus for scaling teeth.

### BACKGROUND ART

An ultrasonic scaler is a device that removes plaque using a micro-flow of ultrasonic vibration, and is an effective device to remove a large amount of plaque in a short time. Currently, the ultrasonic scaler has been becoming thinner and more technically developed, and has expanded treatment coverage using various tips.

Since a conventional ultrasonic scaler includes a foot switch, only when the foot switch is stepped on, the ultrasonic scaler is operated to apply ultrasonic waves to plaque from a tip. Therefore, an operator should continuously operate the ultrasonic scaler with a foot while performing a plaque removal operation, thereby the operator may get a disease, such as a muscular pain, in his/her ankle or leg. That is, the conventional ultrasonic scaler is turned on or off through the foot switch, and thus there are problems in that the operator gets the disease and fatigue is caused.

Also, when the operator wrongly operates the foot switch by mistake, there is a risk of injury to the operator and a patient.

### DISCLOSURE

### Technical Problem

An object of the present application is to provide a method and apparatus for scaling teeth capable of preventing a disease, such as a muscular pain, of an operator and a risk of injury to the operator and a patient due to malfunction of a foot switch.

### Technical Solution

As a technical solution to solve the technical problem, a method of scaling teeth according to one aspect of the present application may include a step of sensing a parameter difference between a scaler tip and a suction tip or a change in each parameter of the scaler tip and the suction tip through a sensor unit; a step of determining whether the parameter difference or each of the parameters that appears when the scaler tip is in contact with a tooth and the suction tip is in contact with an oral cavity changes within the criteria range; and a step of operating the scaler tip and the suction tip when the parameter difference or each of the parameters is within the criteria range.

As a technical solution to solve the technical problem, an apparatus of scaling teeth according to another aspect of the present application may include a scaler unit including a scaler tip applying ultrasonic waves, and a hand piece connected with the scaler tip; a suction unit including a suction tip inserted into an oral cavity, and a suction tube connected with the suction tip; a sensor unit sensing a parameter difference between the scaler tip and the suction tip or a change in each parameter between the scaler tip and the suction tip; and a control unit configured to determine whether the parameter difference or each of the parameters that appears when the scaler tip is in contact with a tooth and the suction tip is positioned inside an oral cavity changes within the criteria range, and operate the scaler tip and the suction tip when the parameter difference or each of the parameters is within the criteria range.

### Advantageous Effects

According to a technical solution of the above-described present application, the method and apparatus for scaling teeth can automatically operate a scaler tip and a suction tip by sensing a parameter difference between the scaler tip and the suction tip and a change in each parameter through a sensor unit, thereby preventing a disease and fatigue caused to an operator and preventing injuries to the operator and a patient.

### DESCRIPTION OF DRAWINGS

FIG. 1 is a full flowchart of a method of scaling teeth according to an embodiment of the present application;

FIG. 2 is a schematic diagram of an apparatus for scaling teeth according to an embodiment of the present application;

FIG. 3 is a block diagram of the apparatus for scaling teeth according to the embodiment of the present application;

FIG. 4 is a block diagram illustrating a more specific implemented example of FIG. 3;

FIG. 5 is a schematic diagram for describing an operational method of the apparatus for scaling teeth according to the embodiment of the present application; and

FIG. 6 is a schematic diagram of a partial configuration of a suction unit for describing coupling or separation between a suction tip and a suction tube.

### MODES OF THE INVENTION

Hereinafter, embodiments that are easily performed by those skilled in the art will be described in detail with reference to the accompanying drawings. However, embodiments of the present application may be implemented in several different forms, and are not limited to embodiments described herein. In addition, parts irrelevant to the description are omitted in the drawings in order to clearly explain embodiments of the present application. Similar parts are denoted by similar reference numerals throughout this specification.

Throughout this description of the present application, when a part is positioned “on” another part, both a case where the part is located directly on another part and a case where still another element is present between the parts are included.

Throughout this description of the present application, when a portion “includes” an element, another element may be further included, rather than excluding the existence of the other element, unless otherwise described. The term “approximately” and/or “substantially” used throughout this description of the present application are used to mean the numerals or approximations of numerals when manufacturing and material tolerances that are inherent to the corresponding meanings are presented, and are used to prevent an unconscientious infringer from unfairly using disclosed contents in which accurate or absolute numerals are given to assist understanding of the present application. The terms “˜(doing) step” or “step of ˜” that are used in the entire description of the present application do not mean “step for ˜”.

Throughout the description of the present application, the term “combination thereof” included in the Markush type expression refers to a mixture or combination of one or more selected from a group consisting of constituent elements described in the Markush type expression, and refers to one or more selected from the group consisting of the above-described constituent elements.

Hereafter, the present application will be described in detail with reference to the accompanying drawings.

First, a method of scaling teeth (hereafter referred to as the method of scaling teeth) according to the present application will be described.

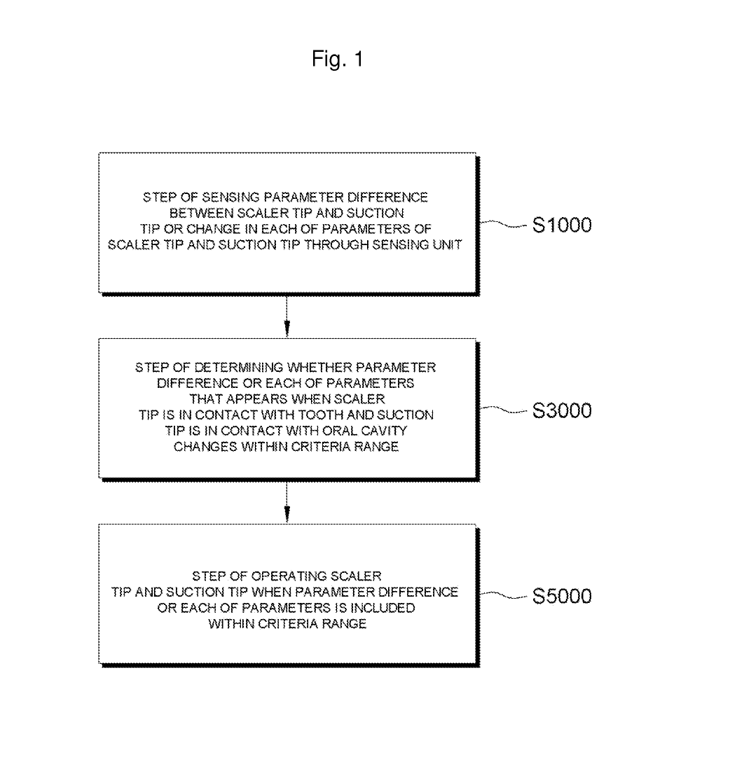

FIG. 1 is a full flowchart of a method of scaling teeth according to an embodiment of the present application.

The method of scaling teeth includes step (S 1000) of sensing a parameter difference between a scaler tip 11 and a suction tip 31 or a parameter change of each of the scaler tip 11 and the suction tip 31 through a sensor unit 50.

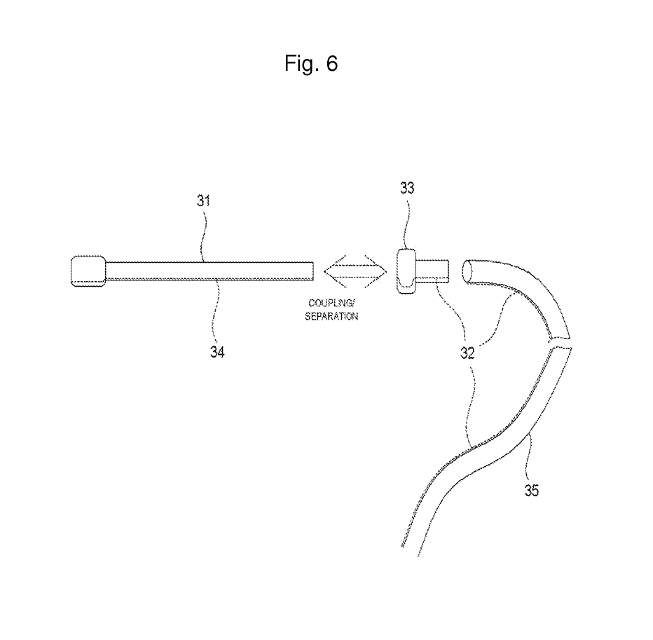

For example, referring to FIG. 6, in the sensor unit 50, the suction tip 31 may include a suction sensor 34 for sensing a parameter.

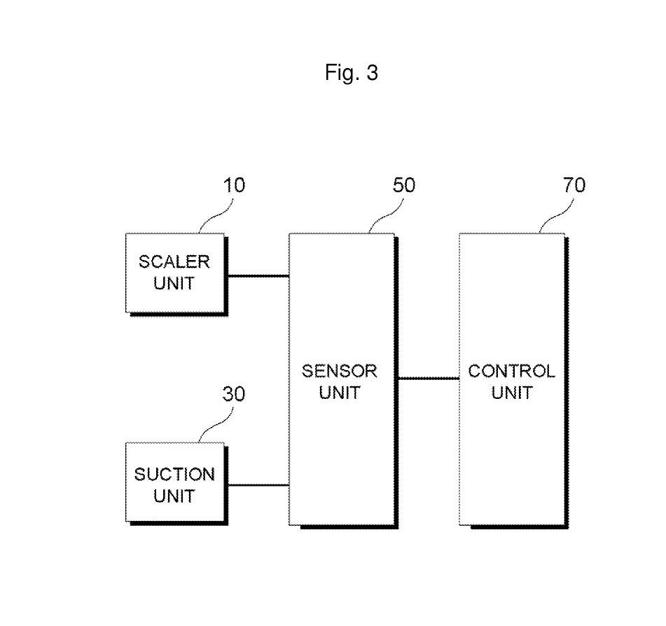

Referring to FIGS. 3 to 5, the sensor unit 50 may transfer the parameter difference and each of the parameter changes to a control unit 70.

A change in the parameter difference and a schematic difference between each of the parameter changes will be described below with reference to more specific exemplary embodiments of the parameters.

In step (S 1000) of sensing through the sensor unit 50, when the change in the parameter difference is sensed, the parameter difference may be any one difference among resistance, inductance, capacity and impedance formed between the scaler tip 11 and the suction tip 31. In this case, a criteria range may be a range for any one difference of the resistance, the inductance, the capacity and the impedance that appear when the scaler tip 11 is in contact with a tooth and the suction tip 31 is in contact with an oral cavity.

When the scaler tip 11 is not in contact with the tooth or gums, an impedance difference between the scaler tip 11 and the suction tip 31 may be infinite. When the suction tip 31 is in contact with the oral cavity and the scaler tip 11 is in contact with the tooth or the gums, the impedance difference between the scaler tip 11 and the suction tip 31 may be less than infinity. The sensor unit 50 may read a change in the impedance difference generated when the scaler tip 11 is changed from a state of not being in contact with the tooth or the gums to a state of being in contact with the tooth or the gums or vice versa.

The criteria range, which is a criterion for operating the scaler tip 11 and the suction tip 31, may be set to correspond to types of parameters sensed by the sensor unit 50. Therefore, when the sensor unit 50 senses the impedance difference between the scaler tip 11 and the suction tip 31, the criteria range may be set to an impedance difference value.

For example, when the suction tip 31 is in contact with the oral cavity and the scaler tip 11 is in contact with the tooth or the gums, the impedance difference formed between the scaler tip 11 and the suction tip 31 is less than or equal to 2 MOhm, and the impedance difference may be set as the criteria range.

Since impedance results from the combination of the resistance, the inductance, and the capacity, even when types of the parameter differences that the sensor unit 50 senses are the resistance, the inductance, and the capacity, the resistance, the inductance, and the capacity may be implemented to be similar to an implemented example of the above-described impedance.

For example, if the parameter difference that the sensor unit 50 senses is the resistance difference, when the scaler tip 11 is not in contact with the tooth or the gums, the resistance difference between the scaler tip 11 and the suction tip 31 may be infinite, and when the suction tip 31 is in contact with the oral cavity and the scaler tip 11 is in contact with the tooth or the gums, the resistance difference between the scaler tip 11 and the suction tip 31 may be less than infinity.

For another example, the sensor unit 50 may sense a change in a light amount, a proximity distance, and a magnetic field of each of the scaler tip 11 and the suction tip 31. For example, sensors are each provided in the scaler tip 11 and the suction tip 31 to sense the change in the light amount, the proximity distance, and the magnetic field of each of the scaler tip 11 and the suction tip 31.

In this case, the criteria range may be a range of values that each of the parameters may have when the scaler tip 11 is in contact with a tooth and the suction tip 31 is in contact with the oral cavity. For example, when the sensor unit 50 senses a change in the light amount of each of the scaler tip 11 and the suction tip 31, the criteria range may be set to a range of each of the light amount that appears when the scaler tip 11 is in contact with the tooth and the suction tip 31 is in contact with the oral cavity.

Also, for example, when the sensor unit 50 senses a change in the magnetic field, the criteria range may be set to a range of each magnetic field that appears when the scaler tip 11 is in contact with the tooth and the suction tip 31 is in contact with the oral cavity.

Also, for example, when the sensor unit 50 senses the proximity distance, the criteria range may be a distance range between the scaler tip 11 and the tooth when the scaler tip 11 is in contact with the tooth, and a distance range between the suction tip 31 and a contact surface between the suction tip 31 and the oral cavity when the suction tip 31 is in contact with the oral cavity.

The method of scaling teeth includes step (S3000) of determining whether the parameter difference or each of the parameters changes within the criteria range, which appears when the scaler tip 11 is in contact with the tooth and the suction tip 31 is positioned inside the oral cavity.

In this case, the parameter difference refers to a relative difference of parameters sensed from the scaler tip 11 and the suction tip 31. For example, when the suction tip 31 is in contact with the oral cavity and the scaler tip 11 is not in contact with the oral cavity, there may be a large resistance difference between the scaler tip 11 and the suction tip 31. However, when both of the suction tip 31 and the scaler tip 11 are in contact with the oral cavity, there may be a small resistance difference between the scaler tip 11 and the suction tip 31.

Meanwhile, each parameter refers to an absolute parameter value, indicating a case where the scaler tip 11 is positioned inside the oral cavity and a case where the suction tip 31 is positioned inside the oral cavity, rather than a relative difference of the parameters sensed from the scaler tip 11 and the suction tip 31. That is, the parameter refers to a parameter value that the suction tip 31 has regardless of the scaler tip 11 when the suction tip 31 is positioned inside the oral cavity, and a parameter value that the scaler tip 11 has regardless of the suction tip 31 when the scaler tip 11 is positioned inside the oral cavity. For example, the parameter may be a light amount in a state in which the scaler tip 11 is closed a predetermined amount or more and a light amount in a state in which the suction tip 31 is closed a predetermined amount or more.

A reason the criteria for determining whether the scaler tip 11 is in contact with the tooth and the suction tip 31 is positioned inside the oral cavity or not is set outside a range of the specific value is as follows.

The parameter difference or each of the parameters that appear when the scaler tip 11 is in contact with the tooth and the suction tip 31 is positioned inside the oral cavity is different depending on objects with which the scaler tip 11 and the suction tip 31 are in contact, and thus the determination criteria may not have a specific value. Therefore, the criteria range may be set within a tolerance which covers the difference at a predetermined reliability level or more.

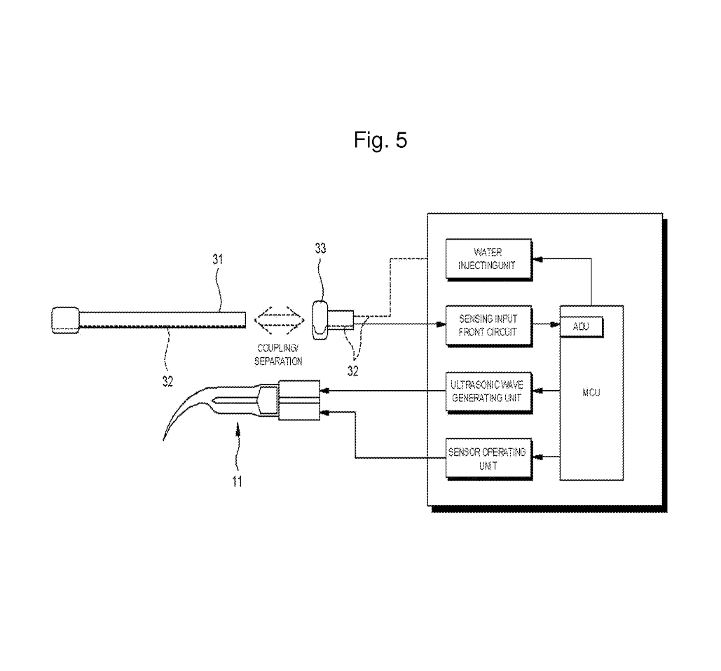

Referring to FIGS. 3 and 5, the control unit 70 may receive parameter information from a sensor line 32 connected with the control unit 70 (or the sensor unit 50 including the sensor line 32) and determines whether the parameter information is within the criteria range.

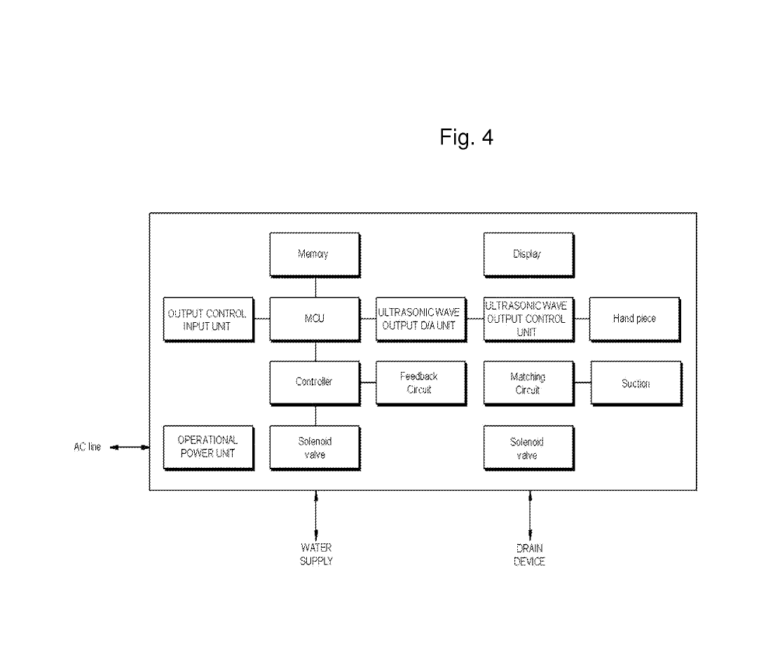

In this case, referring to FIG. 4, the control unit 70 may include a micro controller unit (MCU). Also, it is understood that the control unit 70 includes a controller, a matching circuit, a feedback circuit, and the like.

The method of scaling teeth includes step (S5000) of operating the scaler tip 11 and the suction tip 31 when the parameter difference or each of the parameters is within the criteria range.

For example, as described above, if the criteria range is set to an impedance difference of 2 MOhm or less formed between the scaler tip 11 and the suction tip 31, when the scaler tip 11 is in contact with the tooth or the gums and the suction tip 31 is in contact with the oral cavity and the impedance difference between the scaler tip 11 and the suction tip 31 sensed through the sensor unit 50 is less than 2 MOhm, it is determined that the scaler tip 11 is in contact with the tooth and the gums, and thus power may be input into a scaler unit 10 and a suction unit 30.

Conversely, when the impedance difference between the scaler tip 11 and the suction tip 31 sensed through the sensor unit 50 is greater than 2 MOhm, it is determined that the scaler tip 11 is in contact with the tooth or gums, and thus the power input to the scaler unit 10 and the suction unit 30 may be blocked.

Referring to FIGS. 3 and 5, the control unit 70 connected with the sensor line 32 included in the sensor unit 50 may operate the scaler tip 11 and the suction tip 31.

For example, referring to FIG. 5, the MCU included in the control unit 70 may order an ultrasonic wave generating unit and a water injecting unit to apply ultrasonic waves and water to the scaler tip 11, and operate the suction tip 31.

A conventional ultrasonic scaler includes a foot switch for operating a power supply device, which supplies power to an ultrasonic wave generator, to generate ultrasonic waves, and is operated so that the tip applies ultrasonic waves to plaque only when the foot switch is stepped on. And therefore, since an operator should continuously step on the foot switch during a removal operation of plaque, the operator may get a disease, such as a muscular pain, in his/her ankle and leg. That is, since the conventional ultrasonic scaler is turned on or off through the foot switch, there is a problem of causing fatigue to the operator when the conventional ultrasonic scaler is used for long hours. Also, when the operator wrongly operates the foot switch, there is a risk of injury to the operator and a patient.

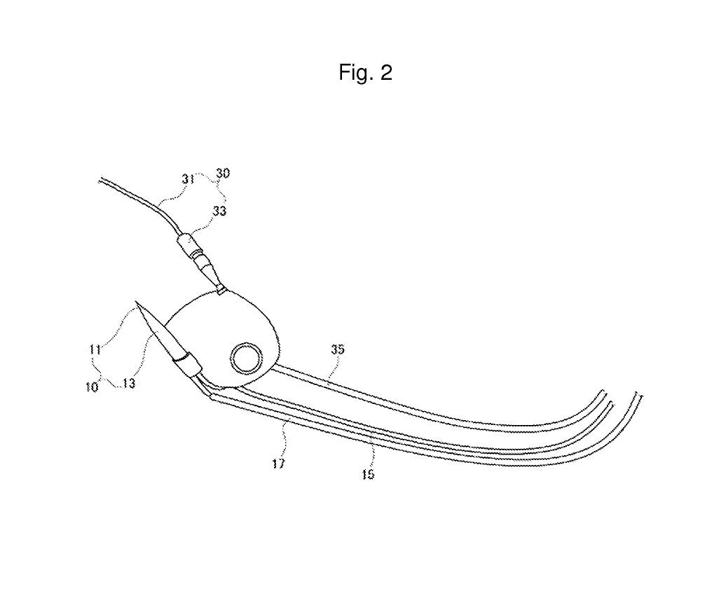

Meanwhile, in the device used in the method of scaling teeth, as shown in FIG. 2, the suction unit 30 and the scaler unit 10 are integrally provided, and thus the parameter difference between the scaler tip 11 and the suction tip 31 or each of the parameter changes may be sensed through the sensor unit 50. Therefore, only when the parameter difference or each of the parameter changes is within the criteria range, the scaler tip 11 and the suction tip 31 may be automatically operated.

That is, according to the method of scaling teeth, scaling is automatically performed without the foot switch, thereby preventing a disease, such as a muscular pain, of the operator. Also, in the method of scaling teeth, only when the scaler tip 11 is in contact with the tooth or the gums in the oral cavity, the scaler tip 11 and the suction tip 31 are operated, thereby increasing safety by preventing a risk of damage to the operator and the patient due to malfunction.

Also, conventionally, a suction device is provided separately from a scaling device, however, the device used in the method of scaling teeth is integrally provided with the scaler unit 10 and the suction unit 30, and thus it is not necessary to provide a separate suction device.

Step (S5000) of operating the scaler tip 11 and the suction tip 31, when the parameter difference or each of the parameters is within the criteria range, may include a step of operating the scaler tip 11 to apply ultrasonic waves and water from the scaler tip 11.

For example, referring to FIG. 5, the ultrasonic wave generating unit (for example, an ultrasonic wave output digital-to-analog (D/A) unit of FIG. 4 and an ultrasonic wave output control unit) and the water injecting unit may apply ultrasonic waves and water to the scaler tip 11 by receiving an ultrasonic wave generation command and a water supply command from the MCU.

Referring to FIG. 2, the water injected from the scaler tip 11 may be applied to the scaler tip 11 along a water line 15.

Also, step (S5000) of operating the scaler tip 11 and the suction tip 31 may include a step of operating the suction tip 31 so that the suction tip 31 suctions the water.

The suction tip 31 may suction water mixed with plaque separated from the teeth by the ultrasonic wave applied from the scaler tip 11 and drain the water.

After step (S5000) of operating the scaler tip 11 and the suction tip 31, the step of operating the scaler tip 11 and the suction tip 31 may be included when the parameter difference or each of the parameters is not within the criteria range.

For example, referring to FIGS. 4 and 5, when the scaler tip 11 and the suction tip 31 are operated, the MCU may stop operations of the scaler tip 11 and the suction tip 31 when it is determined that the parameter information (parameter difference or each of the parameters) is not within the criteria range.

Meanwhile, a computer readable recording medium according to an embodiment of the present invention may include a program instruction for executing the method of scaling teeth described above.

That is, the embodiment of the present invention may include a computer readable recording medium including a program instruction for executing operations implemented by various computers. The medium records a program or process for executing the method of scaling teeth as described above. The media may include a program instruction, a local data file, a local data structure, and/or combinations thereof. Examples of the computer readable recording medium include magnetic media such as a hard disk, a floppy disk, and a magnetic tape, optical media such as a compact disc read only memory (CD-ROM) and a digital versatile disc (DVD), magneto-optical media such as a floptical disk, and a hardware device such as a read only memory (ROM), a random access memory (RAM), or a flash memory, that is specially made to store and perform the program instruction. Or, the media may include transmission media such as a waveguide, a metal strip, or lights including a carrier wave for transmitting a signal designating the program instruction, the data structure, or the like. Examples of the program instruction may include a machine code generated by a compiler and a high-level language code that can be executed in a computer using an interpreter.

Meanwhile, the apparatus for scaling teeth according to the embodiment of the present application (hereafter, referred to as the apparatus for scaling teeth) will be described. However, like or similar configuration described in the method of scaling teeth according to the above-described embodiment of the present application is denoted by the same reference numerals, and redundant description will be briefly described or omitted.

The apparatus for scaling teeth includes the scaler unit 10.

The scaler unit 10 includes the scaler tip 11 to apply ultrasonic waves. Also, the scaler unit 10, as shown in FIG. 2, includes a hand piece 13 connected with the scaler tip 11.

The scaler tip 11 may apply the ultrasonic waves to remove plaque.

The scaler unit 10 may be operated or stopped by power applied or blocked by the control unit 70.

The apparatus for scaling teeth includes the suction unit 30.

The suction unit 30 includes the suction tip 31 inserted into an oral cavity. Also, the suction unit 30, as shown in FIG. 2, includes a suction tube 35 connected with the suction tip 31.

The suction tip 31 may suction water mixed with plaque separated from the tooth by the ultrasonic waves applied from the scaler tip 11. The water may be drained by moving along the suction tube 35.

The conventional apparatus for scaling teeth separately includes a suction device suctioning the water generated during scaling.

Meanwhile, the apparatus for scaling teeth, as shown in FIG. 2, includes the suction unit 30 and the scaler unit 10 in the same device, and thus it is not necessary to include a suction device through separate equipment.

Therefore, the suction unit 30 and the scaler unit 10 are interlocked with each other, and thus parameter information for operating the suction tip 31 and the scaler tip 11 may be obtained.

Referring to FIG. 6, a suction tip connecting unit 33 may be provided at one end of the suction tube 35, so that the suction tip 31 may be coupled to or separated from the suction tube 35.

Therefore, the apparatus for scaling teeth may facilitate exchange of the suction tip 31, which is a disposable product, from the suction tube 35.

For example, the suction tip 31 and the suction tip connecting unit 33 may be coupled to each other through insertion coupling, male and female coupling, and the like.

Referring to FIG. 6, a suction sensor 34 may be provided in the suction tip 31 to sense when the suction tip 31 is positioned inside the oral cavity. Also, a sensor line 32 may be installed in the suction tube 35 connected with the sensor unit 50.

The suction sensor 34 and the sensor line 32 may be connected with each other when the suction tip 31 and the suction tip connecting unit 33 are coupled to each other.

Therefore, information on a parameter difference between the suction tip 31 and the scaler tip 11 or information on a parameter change in each of the suction tip 31 and the scaler tip 11 may be transferred to the control unit 70.

The apparatus for scaling teeth includes the sensor unit 50.

The sensor unit 50 senses a change in each of parameters between the scaler tip 11 and the suction tip 31 or a change in each of parameters of the scaler tip 11 and the suction tip 31.

For example, the sensor unit 50, referring to FIGS. 5 and 6, may include the sensor line 32 and the suction sensor 34.

The apparatus for scaling teeth includes the control unit 70.

The control unit 70 determines whether the parameter difference or each of the parameters that appears when the scaler tip 11 is in contact with a tooth and the suction tip 31 is positioned inside the oral cavity changes within the criteria range, and operates the scaler tip 11 and the suction tip 31 when the parameter difference or each of the parameters is within the criteria range.

Since the parameter difference or each of the parameters that appears when the scaler tip 11 is in contact with a tooth and the suction tip 31 is positioned inside the oral cavity is different depending on objects with which the scaler tip 11 and the suction tip 31 are in contact, a determination criteria may not have a specific value and may be set to a range within a tolerance capable of covering the difference at a predetermined reliability level or more.

For example, referring to FIG. 4, the control unit 70 may include the MCU. Also, it is understood that the control unit 70 includes the controller, the matching circuit, the feedback circuit, and the like.

When the sensor unit 50 senses the parameter difference, the parameter difference may be any one difference among resistance, inductance, capacity, and impedance formed between the scaler tip 11 and the suction tip 31. In this case, the control unit 70 may be set to a range for any one difference among the resistance, the inductance, the capacity, and the impedance that appear when the scaler tip 11 is in contact with the tooth and the suction tip 31 is in contact with the oral cavity.

For example, when the scaler tip 11 is not in contact with the tooth or gums, an impedance difference between the scaler tip 11 and the suction tip 31 may be infinite. When the suction tip 31 is in contact with the oral cavity and the scaler tip 11 is in contact with the tooth or the gums, the impedance difference between the scaler tip 11 and the suction tip 31 is less than infinity. Therefore, the sensor unit 50 may read the impedance difference including a change in a resistance value.

The criteria range is a criterion for operating the scaler tip 11 and the suction tip 31 and may be set to correspond to what the sensor unit 50 senses. Therefore, when the sensor unit 50 senses the impedance difference between the scaler tip 11 and the suction tip 31, the criteria range may be set to a range for the impedance difference.

For another example, when the sensor unit 50 senses a change in each of parameters between the scaler tip 11 and the suction tip 31, each of the parameters may be any one among a magnetic field, a light amount, and a proximity distance. In this case, the criteria range may be a range of each of the parameters when the scaler tip 11 is in contact with the tooth and the suction tip 31 is in contact with the oral cavity.

The control unit 70 may operate the scaler tip 11 to apply ultrasonic waves and water from the scaler tip 11 when the parameter difference or each of the parameters is within the criteria range.

In this case, the parameter difference refers to a relative difference of the parameters sensed from the scaler tip 11 and the suction tip 31.

Meanwhile, each of the parameters refers to an absolute parameter value indicating a case where the scaler tip 11 is positioned inside the oral cavity and an absolute parameter value indicating a case where the suction tip 31 is positioned inside the oral cavity rather than the relative difference of the parameters sensed from the scaler tip 11 and the suction tip 31. That is, each of the parameters refers to a parameter value that the suction tip 31 has regardless of the scaler tip 11 when the suction tip 31 is positioned inside the oral cavity, and to a parameter value that the scaler tip 11 has regardless of the suction tip 31 when the scaler tip 11 is positioned inside the oral cavity.

For example, as described above, referring to FIG. 5, ultrasonic waves may be applied by the ultrasonic wave generating unit from the scaler tip 11, and water may be injected by the water injecting unit.

Also, the control unit 70 may operate the suction tip 31 to suction water when the parameter difference or each of the parameters is included within the criteria range.

The control unit 70 may stop the operation of the scaler tip 11 and the suction tip 31 when the parameter difference or each of the parameters is not within the criteria range.

As described above, for example, referring to FIGS. 4 and 5, the MCU may stop operations of the scaler tip 11 and the suction tip 31 when it is determined that parameter information (the parameter difference or each of the parameters) is not within the criteria range when the scaler tip 11 and the suction tip 31 are operated.

In the method of scaling teeth and the apparatus for scaling teeth, the apparatus for scaling teeth is automatically operated when the scaler tip 11 is in contact with a tooth or gums of a patient and is automatically stopped when the scaler tip 11 is separated from the tooth and the gums of the patient, thereby preventing fatigue caused in an ankle and leg of an operator due to long hour use of a conventional foot switch. Also, the method and apparatus for scaling teeth can prevent a risk of damage to the operator and the patient when the foot switch malfunctions due to a mistake of the operator.

The above description of the present application is only exemplary, and it will be understood by those skilled in the art that the present application may be implemented in other concrete forms without changing the technological scope and essential features. Therefore, the above-described embodiments should be considered as only examples in all aspects and not for purposes of limitation. For example, each component described as a single type may be realized in a distributed manner, and similarly, components that are described as being distributed may be realized in a coupled manner.

The scope of the present application is defined not by the detailed description but by the appended claims, and encompasses all modifications or alterations derived from meanings, the scope and equivalents of the appended claims.

1. A method of scaling teeth, comprising:
a step of sensing a parameter difference between a scaler tip and a suction tip or a change in each parameter of the scaler tip and the suction tip through a sensor unit;
a step of determining whether the parameter difference or the each of the parameters that appears when the scaler tip is in contact with a tooth and the suction tip is in contact with an oral cavity changes within a criteria range; and
a step of operating the scaler tip and the suction tip when the parameter difference or each of the parameters is included within the criteria range.

2. The method of claim 1, wherein the step of sensing through the sensor unit includes sensing a change in the parameter difference, wherein the parameter difference is any one difference among resistance, inductance, capacity, and impedance formed between the scaler tip and the suction tip, and a criteria range is any one difference among the resistance, the inductance, the capacity, and the impedance that appear when the scaler tip is in contact with the tooth and the suction tip is in contact with the oral cavity.

3. The method of claim 1, wherein the step of sensing through the sensor unit includes sensing a change in each of the parameters, wherein each of the parameters is any one among a light amount, a proximity distance, and a magnetic field of each of the scaler tip and the suction tip, and the criteria range is a range of value that each of the parameters has when the scaler tip is in contact with the tooth and the suction tip is in contact with the oral cavity.

4. The method of claim 1, wherein the step of operating the scaler tip and the suction tip includes operating the scaler tip to apply ultrasonic waves and water from the scaler tip when the parameter difference or each of the parameters is within the criteria range, and operating the suction tip so that the suction tip suctions the water.

5. The method of claim 1, after the step of operating the scaler tip and the suction tip, comprising stopping operations of the scaler tip and the suction tip when the parameter difference or each of the parameters is not included within the criteria range.

6. A computer-readable recording medium recording a program causing a computer to execute the method according to claim 1.

7. An apparatus for scaling teeth, comprising:
a scaler unit including a scaler tip applying ultrasonic waves, and a hand piece connected with the scaler tip;
a suction unit including a suction tip inserted into an oral cavity, and a suction tube connected with the suction tip;
a sensor unit sensing a parameter difference between the scaler tip and the suction tip or a change in each parameter between the scaler tip and the suction tip; and
a control unit configured to determine whether the parameter difference or each of the parameters that appears when the scaler tip is in contact with a tooth and the suction tip is positioned inside an oral cavity changes within a criteria range, and operate the scaler tip and the suction tip when the parameter difference or each of the parameters is included within the criteria range.

8. The apparatus of claim 7, wherein the sensor unit senses a change in the parameter difference, wherein the parameter difference is any one difference among a resistance, an inductance, a capacity, and an impedance formed between the scaler tip and the suction tip, and the control unit is configured to set the criteria range to a range for any one difference of the resistance, the inductance, the capacity, and the impedance that appear when the scaler tip is in contact with the tooth and the suction tip is in contact with the oral cavity.

9. The apparatus of claim 7, wherein the sensor unit senses a change in each of the parameters, wherein each of the parameters is any one of a light amount, a proximity distance, and a magnetic field of each of the scaler tip and the suction tip, and the criteria range is a range of a value that each of the parameters has when the scaler tip is in contact with the tooth and the suction tip is in contact with the oral cavity.

10. The apparatus of claim 7, wherein the control unit is configured to operate the scaler tip to apply ultrasonic waves and water from the scaler tip when the parameter difference or each of the parameters is within the criteria range, and operate the suction tip so that the suction tip suctions water.

11. The apparatus of claim 7, wherein the control unit is configured to stop operations of the scaler tip and the suction tip when the parameter difference or each of the parameters is not included within the criteria range.

12. The apparatus of claim 7, wherein the suction tube includes a suction tip connecting unit provided at one end thereof so that the suction tip can be coupled to or separated from the suction tube.

13. The apparatus of claim 12, wherein the suction tip includes a suction sensor sensing when the suction tip is positioned inside the oral cavity, wherein the suction tube includes a sensor line connected with the sensor unit, and the suction sensor and the sensor line are connected with each other when the suction tip is coupled to the suction tip connecting unit.

14. A computer-readable recording medium recording a program causing a computer to execute the method according to claim 2.

15. A computer-readable recording medium recording a program causing a computer to execute the method according to claim 3.

16. A computer-readable recording medium recording a program causing a computer to execute the method according to claim 4.

17. A computer-readable recording medium recording a program causing a computer to execute the method according to claim 5.
